(19) United States
(12) Patent Application Publication
(10) Pub. No.: US 2008/0003546 A1
(43) Pub. Date: Jan. 3, 2008

(54) ANIMATED DIGITAL CHARTED YARNCRAFT INSTRUCTION

(76) Inventors: Kimberly L. Dunbar, Milan, MI (US); Moon S. Chung, Milan, MI (US)

Correspondence Address: DICKINSON WRIGHT PLLC, 38525 WOODWARD AVENUE, SUITE 2000, BLOOMFIELD HILLS, MI, 48304-2970, US

(21) Appl. No.: 11/769,279

(22) Filed: Jun. 27, 2007

Related U.S. Application Data
(60) Provisional application No. 60/806,194, filed on Jun. 29, 2006.

(51) Int. Cl. G09B 19/20

(52) U.S. Cl. 434/95; 434/308

(57) ABSTRACT

A method of animated yarncraft instruction includes providing a digital graphic file having a video object and an animated image object within the file. The animated image object is instructional of needlework and corresponds to the video object. Moreover, the animated image object represents individual steps taken for producing a yarncraft project, which is usable to advantage by a needlework hobbyist without resorting to or requiring an understanding of a needlework chart.

### CROSS REFERENCE TO RELATED APPLICATION

This application claims the benefit of application Ser. No. 60/806,194 filed Jun. 29, 2006.

### BACKGROUND OF THE INVENTION

1. Field of the Invention

The present invention relates generally to an instructional video for needlework crafts or yarncraft. More particularly, the present invention relates to an animated instructional video in digital form, such as can be utilized on a handheld PDA, or the like which provides instruction in the field of needlework crafts through the use of symbolic representations of the stitches to be performed by the student and/or a digital model of the project and its components.

2. Description of the Prior Art

Historically, crochet is a well-known type of needlework in which loops of thread, yarn, cloth, or other weaving material is interwoven by means of a single hooked needle, or hook. In crochet, interlocked looped stitches are connected to form numerous items, such as afghans, articles of clothing, and decorative items, in a variety of textures and styles. In the 19th century, a means of communicating patterns for crochet projects through charted symbolic representations for the basic stitches was developed and widely used. As literacy rates for women improved in the U.S. and Europe, this system fell out of favor and written instructions became more common, since the method of written instructions is generally more compact and requires less paper and ink to print as compared to the charted method.

Today, in the U.S. and Europe generally, patterns for crocheted items are a series of written stitch guides (see FIG. 1). Often the words and phrases of these written stitch guides are verbose and/or ambiguous, and often prone to errors, and therefore, complicate the process of crocheting, particularly so for those who are new to the craft. Approximately a third of U.S. women know how to knit and/or crochet, but most do not venture beyond projects such as scarves and afghans employing the most basic of skills.

Due to the inherent limitations of the notations used by written stitch guides, and their tendency toward verbosity and ambiguity, limitations are in turn placed upon the types of projects which may be presented in this format. The format itself assumes that the project is necessarily structured as back-and-forth rows (Row 1, Row 2 . . . ) and accurate description becomes more complicated if this is not the case. Thus, projects presented by craft-related periodicals and books are frequently “dumbed down”, not due to the difficulty of the project itself but rather because of the difficulty in describing the process steps to be taken. The same applies to other types of needlework in addition to crochet.

Alternatively, in other parts of the world outside the U.S. and Europe, graphical representations are still commonly used for crochet patterns in lieu of written stitch guide instructions. The graphical representations are universally known and accepted (“international stitch symbols”) and consist of a variety of symbols in a chart, map or graph. Each square on the graph represents a position in the pattern and has a symbol, which is associated with a particular type of stitch. The charts or graphs are typically produced in books or specialized magazines, as will be understood by one of ordinary skill in the art, and are typically aimed at those who are relatively proficient in crochet or other needlework. Each chart or graph can represent a new pattern or design for a particular work, such as a sweater, afghan or the like or a pattern of one. An exemplary prior art graph is shown in FIG. 1.

Several new “stitch dictionaries” published recently in the U.S. have begun to re-popularize the graphical approach here. The graphical approach provides better visualization of the construction and assembly of pattern pieces, which is especially helpful for projects utilizing forms other than simple back-and-forth row structures. However, the graph is presented in finished form, and it can therefore be difficult to follow and track one's progress, particularly when rows are knitted/crocheted in a back-and-forth fashion—the chart will be read left-to-right or right-to-left depending upon the current row. Additionally, if the project (or portion of it) presented is large and/or complex (such as part of a fancy-stitched sweater), the chart will accordingly be large and/or complex. Graphical instructions for three-dimensional objects such as toys are particularly difficult to visualize and comprehend.

For example, U.S. Pat. No. 4,578,036 shows an alternative method of instruction for knitting and crocheting, which combines a charted format and written notations. In particular, as is typical, a chart showing the instruction for producing a particular needlework article or item from a graph is provided, along with notations guiding its use, and an illustration of the finished product is provided. While the entire chart includes specific needlework instruction for each knit or crocheting step, by way of a symbol, the issues regarding charted patterns in general still remain. It is difficult to keep track of one's progress on the chart, especially given that the chart reads right-to-left or left-to-right depending upon the current row. Visualizing how the finished product will look, how it will fit, and how alterations to improve the fit can be made in advance, forces a difficult leap of the imagination given just the illustration and the pattern components. The addition of a written key and other language-dependent notation also ensures this alternative method of instruction will not be a global solution, as it requires knowledge of written English.

Instructional video to teach needlework skills has become commonly available relatively recently, but current offerings do not utilize graphical representations or animations. These videos all mainly feature filmed close-ups of human hands performing the stitches and completing the project. Generally, the videos do display the finished product and expected results (often worn by a live model) in a 3-dimensional way that is superior to the drawings or photographic illustrations that accompany most written and charted patterns. One recent video offering also included scrolling written instructions alongside the working hands, so the viewer could associate the written instructions with the stitch being performed. Again, however, this is not a global solution since written instructions do vary by language, unlike the international graphical symbols. The “filmed hands” approach also suffers from the limitation of time—projects must be “dumbed down” so as not to take an inordinate amount of time to present, because moving hands are slow (and boring to watch for any extended period of time).

### SUMMARY OF THE INVENTION AND ADVANTAGES

Accordingly, one advantage of the present invention is that it presents stepwise crocheting instruction in a usable, interesting, and readily understandable fashion to a global audience. Once having learned the hand movements for the basic stitches, beginners in the U.S. are now are generally left to struggle with deciphering complex written instructions in order to proceed in developing new skills through more advanced projects. Also, for others possessing ordinary skill, there is a need to provide improved instruction without necessarily referring to a chart, map or graph of the entire product at once. Thus, another advantage of the present invention is to provide a step-by-step instructional approach not initially requiring the user's full understanding of all of the needle steps or instructions contained in the final needlework written pattern or charted map. Another advantage is that the present invention provides the ability to visualize in advance just how a project's components are formed, and how the components specifically fit together into the finished project, is key to the ability to execute the project successfully (and in the case of garments, to make appropriate alterations for improved fit). Such visualization tools can be done with 3-dimensional and 2-dimensional animated graphics.

It is therefore another advantage of the present invention to provide digital charted yarncraft instruction that minimizes the above problems relating to traditional written and charted printed patterns, by providing step-by-step animation to illuminate each needlework step of a pattern based upon an instructional chart, using symbolic representations for the stitches. These symbolic representations may take the form of internationally recognized stitch symbols, a photographic representation of a stitch or a line drawing-type representation of it, or any other representation. In an animated fashion, the graphical representations of stitches gradually build up as a digital “model” of the project, while the user follows along and builds the project in the real world. Along the way, hand movements to demonstrate how to perform the stitches are also briefly presented (by actual human hands, or by animated 3-dimensional or 2-dimensional representations of hands), these demonstrations associated with the graphical symbols and digital project model. Symbolic representation also may take the form of musical notes or other sounds, each associated with a particular stitch type and graphical symbol, such that following the pattern instructions forms a melody to assist the user in tracking repetitive actions.

It is a further advantage of the present invention to provide an animated digital charted yarncraft instruction that is downloadable onto small handheld portable devices, such as an iPod, cellphone or the like. Symbolic representation offers a graphical and step-wise animated means to represent stitch pattern information in a small-screen format. This may offer significant commercial opportunities in the future, as on-line product ordering through internet-ready portable devices becomes widespread. Downloadable instructional video segments may offer a new marketing channel opportunity for yarn craft manufacturers and retailers, since each project requires particular materials as specified.

For the user, instruction in this format will provide for more freedom of movement and “crafting on-the-go”. Modular design (projects made up of many smaller components and finished by joining together) is particularly suited to animated digital charted instruction displayed on a small screen. The combination of the present invention, and using it to present modularly designed projects, will result in enabling crafters with busy schedules—who can carry a bit of yarn and a few tools in the corner of a purse or backpack, along with a cell phone, for use in spare moments while waiting in line or stuck in traffic—to benefit from the noted calming effects associated with yarn crafts.

It is a further advantage of the present invention to provide instruction in a format which is attractive to new crafters, particularly the young, who have grown up with the Internet and have an affinity for new technology, portable technology, 3-D and 2-D animations, and graphical format representations of information.

It is a further advantage of the present invention to provide instruction in a format which assists new crafters in developing their skills, while providing clarity of instructions such that they can successfully complete projects previously considered as ‘intermediate’ (as the designation formerly applied more to the ability to decipher instructions than to the difficulty of the project itself). This combination of benefits will reduce the likelihood that new crafters will under-perform or drop out entirely, and will provide a boost to the yarncraft industry.

For crafters at all experience levels, the present invention will allow for more technically challenging and artistically rewarding projects to be presented, without the confusion associated with written pattern language or large graphical charts. Additionally, the present invention can be easily utilized to light the way for crafters to create their own unique designs, in addition to its use in clarifying instruction for a given specific project.

It is a further advantage of the present invention to offer a global solution, understandable to any viewer worldwide, based on animated graphical stitch representations, along with 3-D and 2-D models, and other animated visualization tools—rather than a particular written or spoken language. In the U.S., promoting the use of international symbols brings us closer to the rest of the world and encourages cross-cultural sharing of artistic knowledge and technique.

Although the figures and attachments herein use the craft of crochet as an example, it is a further advantage of the present invention that it applies to all other needlecrafts which use project charts and symbolic representations for stitches, such as knitting, beadwork, needlepoint, cross-stitch and embroidery, for instance.

In addition to the use of animated or musical symbols to represent stitches in a stepwise fashion, it is a further advantage of the present invention to employ other aspects of visualization technology in the service of yarn craft instruction. These methods include auto-rotoscoping (simplification of the filmed images of actual hands into the format of black-and-white drawings, to assist in focusing the user's attention and decreasing distraction), and the use of 3-D “virtual” hands. Video using virtual hands offers an advantage over the use of actual human hands in demonstrating close-ups of movements relating to a particular stitch, since a “virtual” hand can be instantly rendered invisible if it gets in the way. Just as there are many ways to hold a pencil, crochet hooks are held in a variety of ways and idiosyncrasies can be distracting. Virtual yarn, and virtual tools such as crochet hooks and knitting needles, and virtual stitches can all be instantly rendered invisible in order to make an instructional point clear. FIG. 4 shows several forms that virtual hands can take, depending upon how the user's attention might be most effectively focused.

Other methods employ the use of photo-based stitch symbols to assist in the correct placement of the hook through a yarn loop to form a variety of stitch types, and on a larger scale as a tool to assist with enhanced visualization of a 2-D or 3-D model. Another aspect of the present invention is a technique, “Animated 2-D (or 3-D) virtual assembly”, which is highly useful for demonstrating how a great number of small modular pieces is to be fitted together and joined on a 2-D or 3-D virtual model.

Yet another advantage of the present invention is the use of 3-D models for accurate representation and visualization of the finished product, including the “flyaround view” to see it from various angles. A 3-D model clearly depicts what the finished product looks like, how pattern pieces come together and are joined in the finished product, and how it is expected to fit. The 3-D model can be used in conjunction with international stitch symbols as an overlay, or with photo-based stitch representations overlay, or any other form of stitch representation that assists the user with project visualization.

Animated photographs of stitches, used as a substitute for the international symbols, offer a benefit in that the precise location where the hook should be inserted can be targeted (see FIG. 5), which is particularly useful for those new to the craft, and for those of ordinary skill who are trying out more complicated textured stitches. These stitch representations based on photos, as well as those represented by other types of symbols, can be used to quickly demonstrate in a 2-D fashion a preview of the entire project to come: how each piece will be filled in, showing direction of stitches, types of stitches, and color changes, and how sizing modifications can be made to that piece to improve garment fit (see FIG. 6).

For projects involving many modular components, animated 2-D virtual assembly (see FIG. 7) is useful to demonstrate how the pieces fit together so that the user can visualize what the final result will be (which is sometimes difficult when looking at a pile of small pieces). “Finishing techniques” are often the key to a successful yarn craft project—the smoothness of seams and the expert joining of pattern pieces into the finished product can make the difference between designer quality and that which looks “homemade”, and a crafter who is disappointed with the final result after the hard work of successfully executing the pattern pieces is likely to quit the craft for good. Animation techniques such as these serve to clarify exactly the steps required for a perfect completion.

Yet another advantage of the present invention is the use of 3-D models to represent the finished product. Printed patterns show a drawing or photograph of the finished item, which can be quite misleading regarding the item's true nature in everyday use. For instance, often one completes a written pattern only to find that the shape of a garment is different than it appeared in the photograph due to the model's body positioning or other factors. A 3-D model, based upon an actual item produced by following the pattern, clearly depicts what the finished product looks like, how pattern pieces come together in the finished product, and how it is expected to fit. Modifications to improve garment fit can be demonstrated on the 3D model so that the user can visualize just what sorts of changes are called for, and why. The “flyaround view”, a very useful aspect of 3-D models generally, assists the user in viewing the model from many different angles for clarity of visualization (see FIG. 8). The 3-D model can be overlaid with international stitch symbols (see FIG. 9). The symbols may be gradually built up in an animated fashion to show how sleeves, collars, cuffs, etc. are constructed, and then specifically how pieces are to be joined together, stitch by stitch. Alternately, stitch photograph images can be used as symbols (see FIG. 10), presenting a 3-D model very closely resembling its real world counterpart. Software packages such as PhotoShop are used to develop “brushes” to vary the appearance of stitch photograph images, such that the digitally painted lines resemble different types of yarn (boucle, angora, silk, metallic) to produce a superior 3-D or 2-D model to assist the user with project visualization.

As a further enhancement and time-saving device to visual learning, the present invention additionally employs animated status indicators similar to those used in video games; in order to indicate what section of the project is currently underway, and to alert the viewer at the time a yarn change is required or other special instructions are about to be conveyed. The yarn change indicator can take the form of a manufacturer's label, and can be constantly present to indicate current yarn color and type status throughout the video, thus also serving as a form of background advertising for the makers of the project's materials.

In accordance with the above advantages of the present invention, an animated digital charted yarncraft instruction is disclosed. An instructional device for teaching yarncraft is provided. The device includes a digital graphic file for transmission on an electronic device to a viewer. The digital graphic file includes a video object for audio-visually instructing the viewer to perform at least a first yarncraft maneuver. The digital graphic file also includes an animated image object corresponding to the video object for representing the first yarncraft maneuver.

A method for animated yarncraft instruction includes providing instruction in the field of needlework. The graphic file contains an instructional portion that takes a user step by step through the stitches required to complete the charted design. The file includes a video or digital animation portion that provides step-by-step instruction on how to perform each action required to complete the needlework project as presented. In conjunction with the video portion illustrating the respective actions to be performed, the graphic file also includes an animated image portion that symbolically or graphically represents the respective stitches being illustrated or demonstrated in the video portion. The graphic file thus allows a user to complete the desired needlework item without requiring a needlework chart to be tracked, or deciphering a written pattern.

These and other features and advantages of the present invention will become apparent from the following description of the invention, when viewed in accordance with the accompanying drawings and appended claims.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is an illustration of a graph for a pattern design in completed form as is well known in the art;

FIG. 2 is a schematic illustration of a segment of a method for providing yarncraft instruction file in accordance with one embodiment of the present invention;

FIG. 3 is an illustration of a still frame of the instruction portion in accordance with the exemplary embodiment showing a status indicator;

FIG. 4 displays several forms that virtual hands can take, depending upon how the user's attention might be most effectively focused;

FIG. 5 demonstrates one use of animated photo-based stitch symbols;

FIG. 6 is an illustration of “pattern fill”, demonstrating how stitches are to fill a particular pattern piece;

FIG. 7 is an illustration of the “animated 2-D virtual assembly” method (but same applies the virtual assembly of a form in 3-D format);

FIG. 8 depicts a “flyaround view” of a 3-D virtual model;

FIG. 9 illustrates how the 3-D model appears, with an overlay of international stitch symbols;

FIG. 10 alternatively illustrates how the 3-D model appears, with an overlay of photo-based stitch symbols;

FIG. 11 is a flow chart exemplarily illustrating the contents of the yarncraft instruction graphic file in accordance with one embodiment of the present invention; and

FIGS. 12a through 12w illustrate instructional segments of a graphic file in accordance with an exemplary embodiment of the present invention.

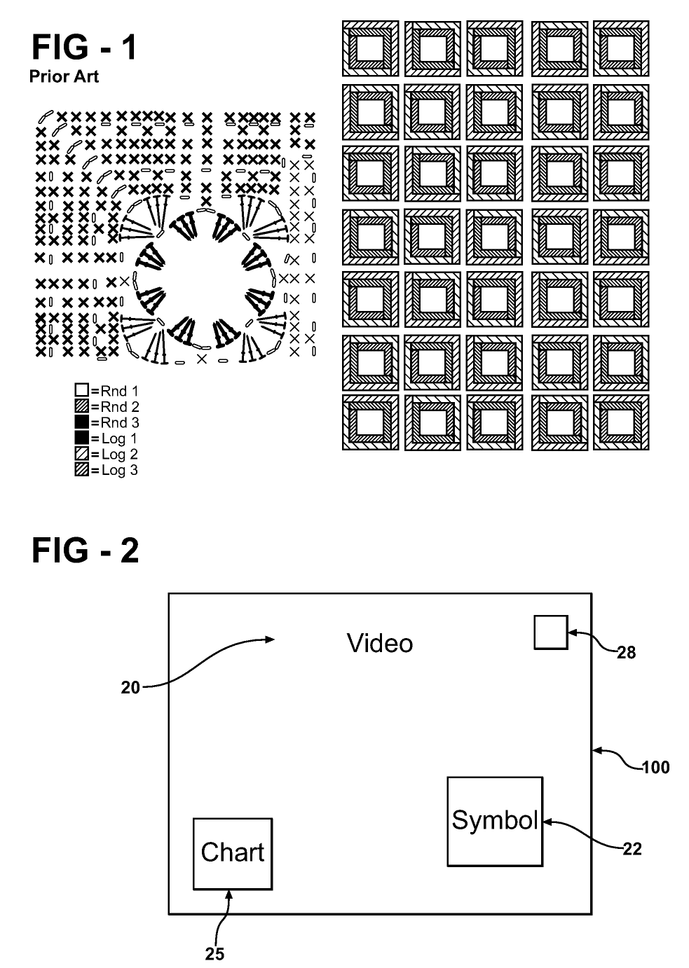

### DETAILED DESCRIPTION OF THE INVENTION

Referring now to the Figures, an instructional device and method for yarncraft instruction are shown according to an exemplary embodiment. As shown in the schematic illustration, in an exemplary embodiment, the device and method for yarncraft instruction includes a digital graphic file 100 that includes a plurality of different segments. The digital graphic file 100 is stored in digital format, such as on a DVD for ease of distribution. However, it will be understood that the digital graphic file 100 can be stored and made available to users and potential users in a variety of other suitable forms, and may be transmitted via an electronic device, such as a television, computer, PDA, or any other portable electronic device. The digital graphic file 100 may also be downloadable from a storage medium, whether DVD or computer, so that it can be separately viewed on devices, such as portable display devices, including without limitation, PDA's, I-Pods or the like. For example, the digital graphic file 100 can be located at a website where it is accessible to users by purchase or otherwise.

With reference to FIG. 2, in accordance with the exemplary embodiment, the digital graphic file 100 visually and audibly depicts instruction for teaching needlework for the making of yarncrafts. More specifically, the digital graphic file 100 contains an instructional portion 116 that visually and audibly depicts and teaches the individual yarncraft maneuvers, or steps, for crocheting or other yarncrafts that are required to complete the pattern design. The instructional portion 116 may include reference to or inclusion of a needlework chart 25 showing a chart, map or graph of the entire item to be crafted charted design form. The chart 25 may be visible at all times or only as selected by a user so that he or she can monitor their progress with respect to the pattern being crafted. Alternatively, the chart 25 could illustrate a user's progress by only showing the stitches completed or the completed stitches could be highlighted while the remaining stitches could be faded in the background. As discussed in more detail below, the digital graphic file 100 preferably includes a video object 20 to show the stitches to be performed in a visual form, such as by showing an artist's hand performing the stitch. The video object 20 is preferably shown in the majority of the screen. This allows the user to visually see the stitch to be performed and practice if desired. The video object 20 of the instruction portion is, for example a video recording, or an animation, of an instructor to audio-visually instruct he viewer how to perform the necessary yarncraft maneuvers.

According to the exemplary embodiment, the instructional portion 116 also includes an animated image object 22, which graphically represents the yarncraft maneuvers, such as the stitch, or step, being visually illustrated. In the exemplary embodiment, the video object 20 corresponds with the animated image object 22 such that the user, or crafter, can simultaneous see both the manual demonstration of the stitch as well as the animated image, which corresponds to that stitch or stitches that together make up the needlework chart 25. The video object 20 may also include audible indications 28, for the teaching of yarncraft to the crafter that relate to the stitch being demonstrated. Also, the video may be presented in forms understood, such as in a film, a digital or analog video, or by slides, including other forms for video presentation. The video object 20 and instruction therein is presented in digital format, enabling the animated image object 22 to be selectively viewed using technologies recognized, including without limitation picture-in-picture format, picture-on-picture, or picture overlay, for example.

As set forth above, the instructional portion 116 is generally compatible with the charted pattern, which is the subject of the graphic file, and is fully shown in the chart 25. It will be understood that the video object 20 includes a downloadable version utilizable for separate presentation either apart from or together with the other segments of the digital graphic file 100. The video object 20, while not necessarily animated in terms of the animated arts, is intended to present or show individual steps for yarncraft construction taught in the yarncraft instructional video. In this regard, the video object 20 shows detailed movement of the needles or other tools used during needlework. According to the exemplary embodiment, the animated image object 22 is displayed in a symbolic form, including plurality of symbolic representations of the yarncraft maneuvers, or steps, and can include the use of international stitch symbols.

However, it will be understood that it can alternatively be displayed in an animated form, an audible form, or a visual depiction to work in coordination with the video object 20 to help the crafter in understanding each stitch to be completed. Therefore, according to a first alternative, the symbolic representations include graphical representations of the yarncraft maneuvers. These graphical representations include a pair of virtual hands demonstrating the yarncraft maneuvers, as well as a flyaround view for displaying the yarncraft maneuvers from a plurality of viewing angles. The virtual hands can be rendered invisible, as needed, making the yarncraft maneuvers more easily visualized. The graphical representation also includes a virtual assembly depicting the assembly of the yarncraft project in order to aide visualization of completion of the yarncraft project. According to a second alternative, the symbolic representation includes a plurality of varying sound patterns associable with the yarncraft maneuvers. The sound patterns can be combined together to form a repeatable melody corresponding to a series of yarncraft maneuvers needed to complete the project. For example, a first sound pattern is associated with a first yarncraft maneuver, and a second sound pattern is associated with a second yarncraft maneuver. The first and second sound patterns, at a minimum, are combined to form the repeatable melody. Thus, in one regard, the animated image object 22 may provide instruction using animation of symbols and/or assigned music or sound to illustrate construction of a stitch, pattern or project involving yarncrafts. The animated image object 22 may also be downloadable and utilizable separate or apart from the remaining portions of the digital graphic file 100.

In the exemplary embodiment, the animated image object 22 is portrayed as a picture-in-picture image along with the video object 20, such that they both appear on the screen simultaneously to assist the crafter in understanding the stitches to be performed, which correspond to the needlework chart 25. The picture-in-picture allows for the instructional step-by-step, piece-by-piece, segment-by-segment, frame by frame or bit-by-bit representation of yarncraft maneuvers, such as the various needle moves for needlework, without regard to the vague instructions typically given in a yarncraft chart.

The video object 20 and the animated image object 22 can both use visual technology to address the creativity gap resulting from the complicated written “language” used to write crochet patterns or other needlework arts. The animated image object 22 will further facilitate teaching and learning of techniques to empower freedom of original design, and away from the pattern-based method of using a chart or by replicating someone else's designs. Providing representative instructions with the animated image object 22 teaches techniques and original creative projects will inspire crafters while on-the-go by providing usable downloadable digital files for ready reference or instruction. To facilitate representative instructions for on-the-go review, the yarncraft instruction for needlework includes providing an animated video representative of an animated image, wherein the animated image is originally included within a video for exemplifying the moves of an instructor teaching needlework. The animated video is a downloadable file for use with a personal video display device. Also, the animated video is a step-by-step representation of needlework. Moreover, the animated video may be a piecewise sequence showing a series of needle movement steps required for needlework.

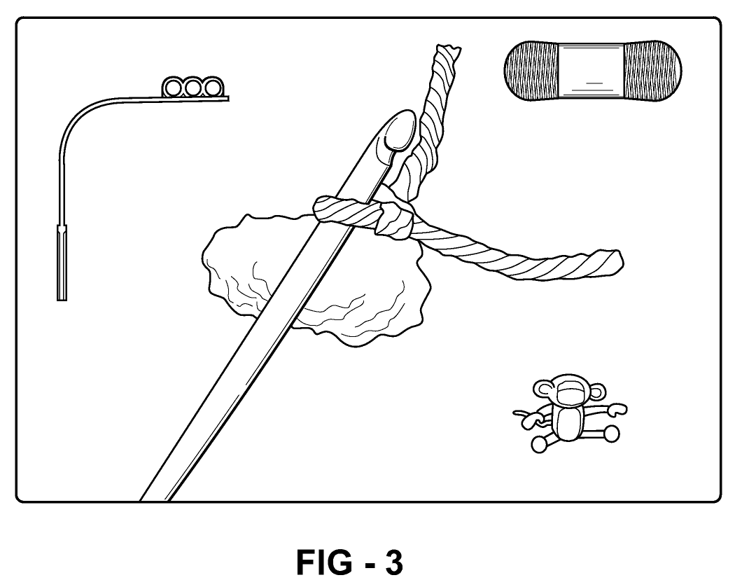

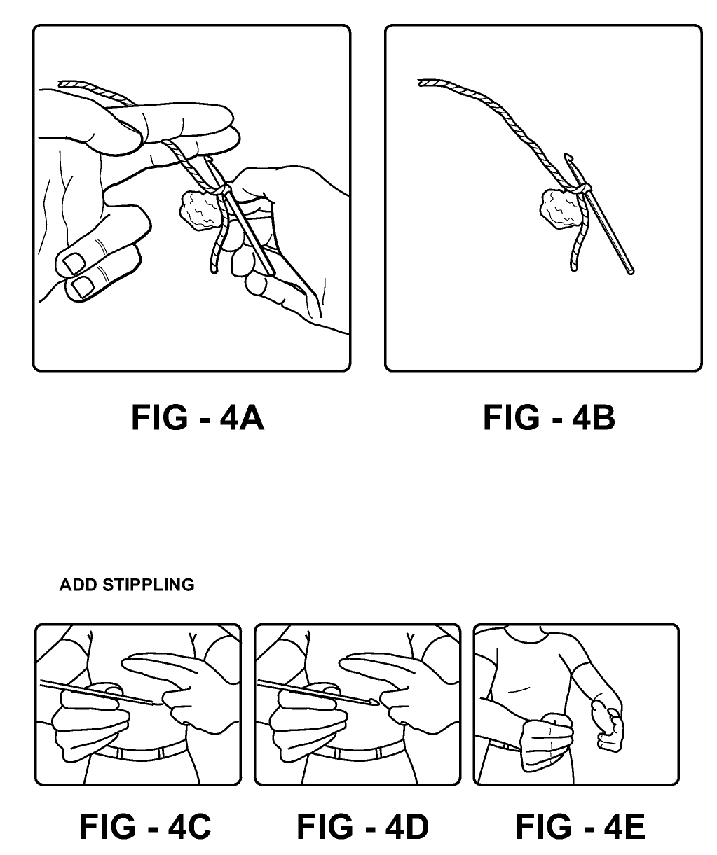

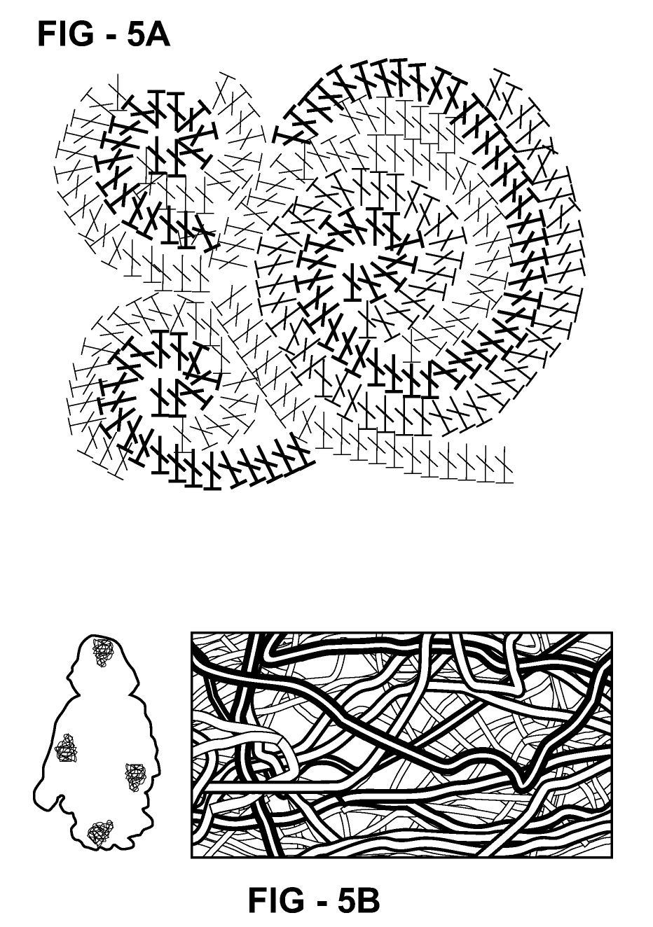

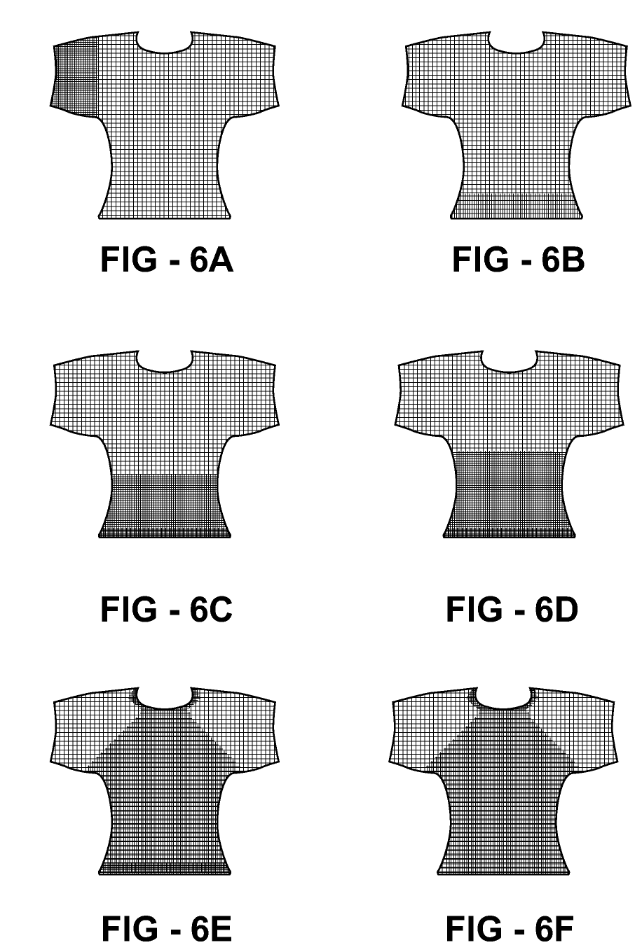

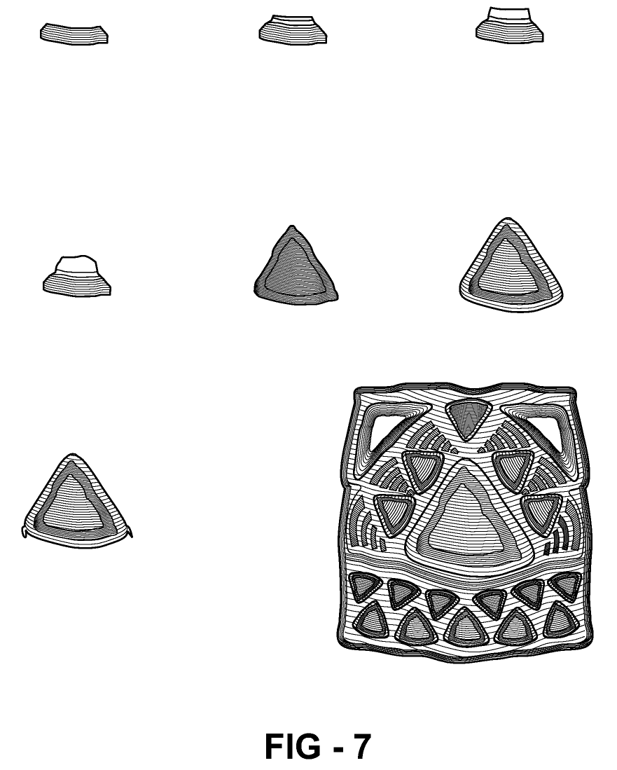

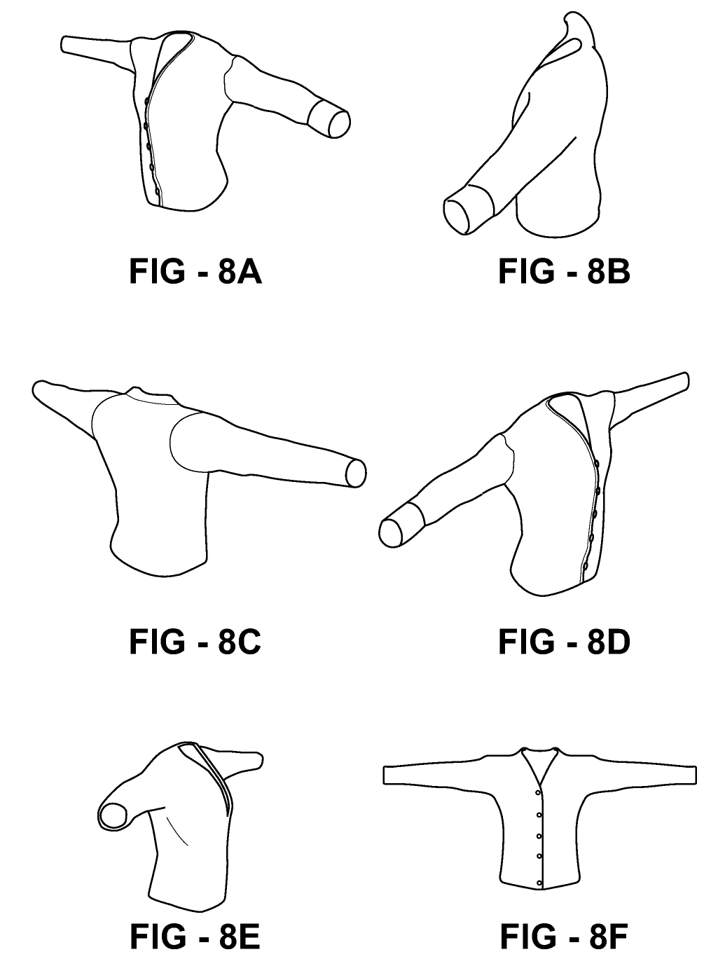

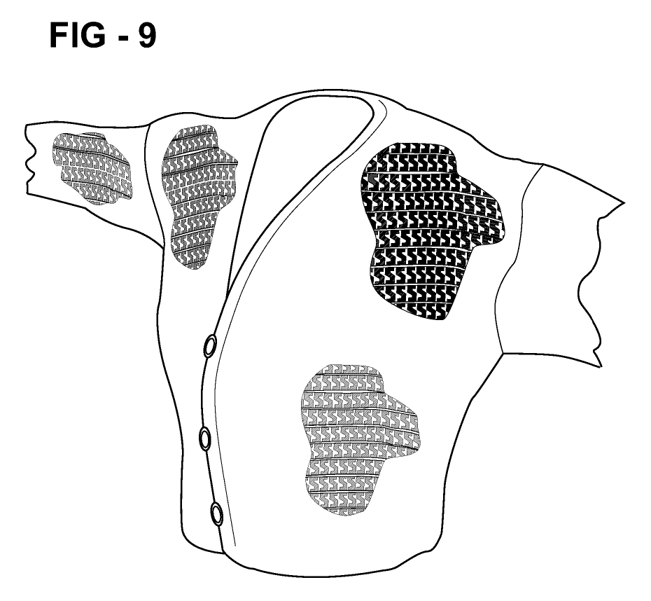

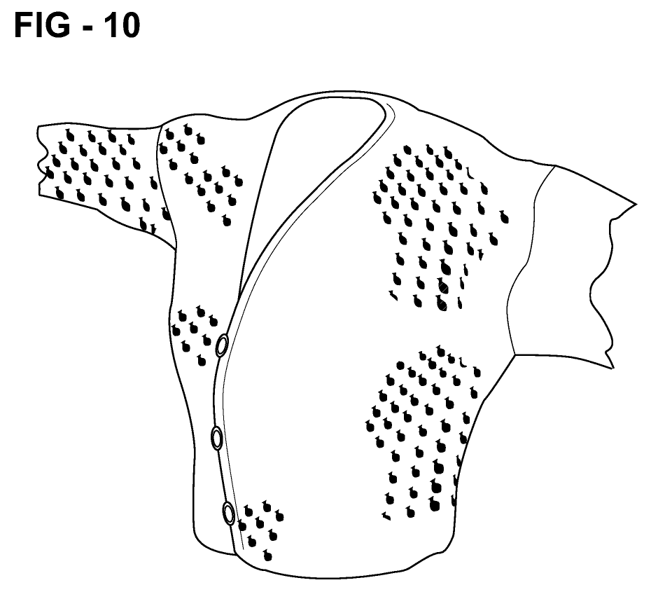

Additionally, the digital graphic file 100 includes a status indicator 30 for indicating and measuring progress of the yarncraft product, as shown in FIG. 3. Employing status indicators 30 throughout the instruction portion assists the user in determining where they are in the project at all times, and makes it much easier to go backward or forward in order to review or preview specific topics in the instructional portion 116. Additionally, status indicators 30 likewise communicate the current material's color and type instantly in a visual way, which is particularly important to avoid making a mistake in a project made with many different colors and types of materials—and as a side benefit, this also keeps the materials manufacturer's label in view at all times during the instructional portion 116. Sounds are assigned to indicate when status indicators 30 change, serving to focus the user's attention at key points where the risk of a mistake is greatest.

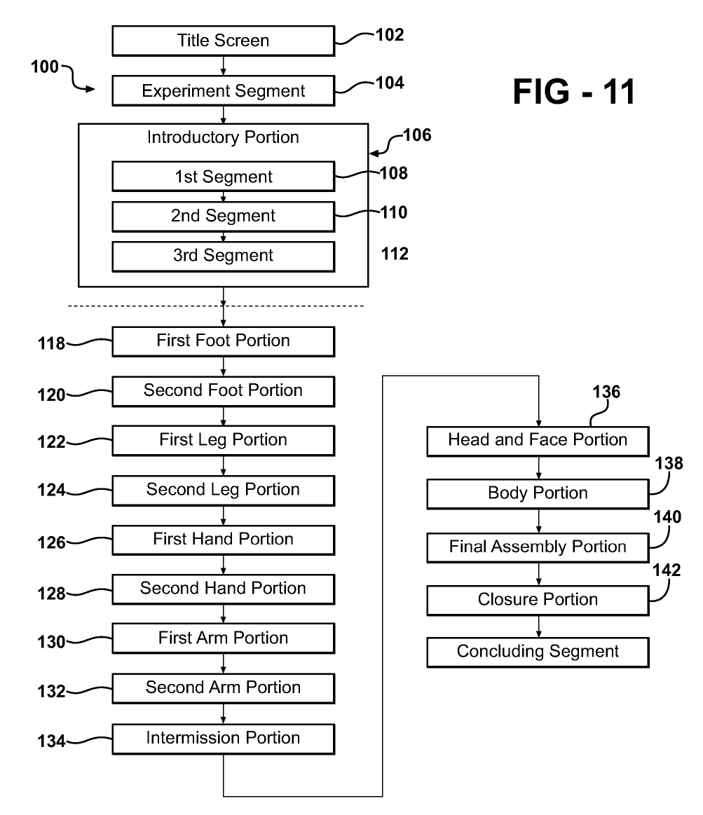

Referring now to FIG. 11, which illustrates a block diagram of the digital graphic file 100 for a needlework instructional video in accordance with the exemplary embodiment of the present invention. As discussed above, the digital graphic file 100 preferably contains a number of different segments, which can vary. The segments of the digital graphic file 100 are discussed in detail below. It also can be appreciated that a different digital graphic file 100 can exist for each different yarncraft pattern to be completed or needleworked. Additionally, while the exemplary embodiment of the present invention is discussed specifically below with respect to crochet, it will also be understood that the present invention can be utilized in connection with other ways for working with charted designs for needlework, including yarn and craft, knitting, cross-stitch, beadwork and the like, as well as other suitable needlework.

As shown in FIG. 11, the digital graphic file 100 contains a title segment 102, which can simply be a title screen. The creator of the digital graphic file 100 as well as other pertinent information, such as the creation date and owner of the file are displayed on the title screen. It should be appreciated that more or less information can be included in the title segment 102, as desired. As set forth above, the digital graphic file 100 is downloadable via the Internet to be played on-demand on a variety of devices, including video iPod, cellphone, handheld computer and the like.

The digital graphic file 100 also contains an entertainment segment 104. The entertainment segment 104 provides some information about or relates to the pattern about which the needlework instruction segment relates. In the exemplary embodiment, the entertainment segment 104 illustrates an animated monkey dancing through Tokyo's Ginza District. Further, in the described embodiment, the digital graphic file 100 relates to the pattern of a Miyaki monkey. It will also be understood that a variety of other information can be included in the entertainment segment 104 as desired.

The digital graphic file 100 also preferably contains an introductory portion 106, which provides background information on the pattern that is the subject of the digital graphic file 100. In the exemplary embodiment, the introductory portion 106 includes various segments. In the first segment 108 of the introductory portion 106, a hostess or narrator provides information about the pattern to be crafted in the digital graphic file 100. For example, the narrator can inform the viewer that the digital graphic file 100 will teach the viewer how to make Miyaki, the playful little monkey. In the exemplary embodiment, Miyaki is the animated monkey illustrated in the entertainment segment 104. It will be understood that the hostess or narrator can be video of a human or computer-generated animation, such as in this embodiment an Avatar. One benefit of utilizing computer-generated animation is that it can be lip-synched to a variety of spoken languages with the voice being added in post-production. Thus, the digital graphic file 100 can be tailored for a variety of different languages.

In the second segment 110 of the introductory portion 106, the hostess or narrator informs the viewer of the materials that will be needed to complete the yarncraft project. For example, to complete the needlework of the monkey, a particular yarn of certain colors and certain needlework tools are required. In addition to the narration that verbally conveys this information, on the screen, the titles of the product as well as the item number of the product and its manufacturer appear on the screen for the user's convenience. By identifying the particular manufacturer, it allows the proprietor of the digital graphic file 100 to sell space to a particular program sponsor. In the third segment 112 of the introductory portion 106, the hostess or narrator verbally informs the user where the required materials can be purchased or obtained. Again, in accordance with the disclosed embodiment, the name of the local craft retailer or other store where these items can be obtained as well as a website link are displayed on the user's screen for their convenience. This also allows the proprietor of the digital graphic file 100 to sell space to another program sponsor as desired. These features create unique marketing opportunities.

In the fourth segment 114 of the introductory portion 106, the hostess or narrator provides a brief explanation of the tools and techniques to be used. Additionally, the hostess or narrator can verbally provide information on the magazine or website where the completed design to be crafted appears as well as the pattern for completing same, such as by providing a link to such a website, if any. Again, if special tools are required, this segment can include another program sponsor in the form of a location where the special materials can be purchased. It will be understood that the introductory portion 106 can consist of more of less segments than described in connection with the exemplary embodiment. It will also be understood that the segments can obviously contain different content as required.

The next portion of the digital graphic file 100 is the instruction portion, and relates to the design of the work to be crafted. The instructional portion 116 also includes a variety of different segments as discussed in more detail below. In the exemplary embodiment, the instructional portion 116 includes the video object 20 and the animated image object 22 for inclusion within and display together with the video object 20. The instruction portion is intended to instruct a user as to how to complete each of the steps or stitches in order to complete the item that is the subject of a particular pattern design.

In accordance with the exemplary embodiment, the first segment 108 of the instructional portion 116 is the first foot portion 118. In the first foot portion 118, the narrator informs the user that the crafting will begin with creating the monkey's foot. The narrator then takes the user step by step through the stitches required to complete the monkey's foot. This portion preferably consists of voice-over pictorial animations, combined with animated and/or video images of hand movements through the steps. The hand movements may be three-dimensional animations done in the same manner as the animated face, as discussed above. For example, the animated image object 22 of the first foot portion 118, as well as the other portions of the instructional portion 116, uses digital animated graphics for yarncraft instruction, including animated symbol charts, rotoscoping, or three-dimensional digital animations of hand movements and project models.

The instructional portion 116 also contains a second segment 110, referred to as the second foot portion 120, which instructs the user to repeat the same functions as described in the first foot portion 118 segment, to complete the second foot portion 120 of the monkey. This allows the user to go back to the beginning of the first segment 108 of the instructional portion 116 and repeat the steps to craft the second foot. Alternatively, the second foot portion 120 can be tailored to simply repeat all the steps required to make the monkey foot so that the viewer need not go back to the first segment 108.

In accordance with the exemplary embodiment, the instructional portion 116 contains a third segment 112, referred to as the first leg portion 122. At the beginning of the third segment 112, the narrator informs the user that the digital graphic file 100 is now going to provide instruction as to how to create the monkey's leg. Like with the other segments, the narrator then takes the user step by step through the stitches required to complete the monkey leg. Thereafter, in the fourth segment 114 of the instructional portion 116, generally referred to as the second leg portion 124, the user can be instructed to return to the beginning of the first leg portion 122 segment to complete the second leg. Alternatively, the steps can all be repeated to allow the user to complete the second leg.

The instructional portion 116 also contains a fifth segment, referred to as the first hand portion 126. In accordance with the exemplary embodiment, at the beginning of the fifth segment, the narrator informs the user that the graphic file is now going to provide instruction as to how to create the first hand portion 126. The first hand portion 126 consists of the same stitch instructions as the first foot portion 118, except that the first hand portion 126 contains stitches directed toward creation of the thumb. The sixth segment of the instructional portion 116 is, referred to as the second hand portion 128, which contains the same instructions as the first hand portion 126. Thus, the narrator could instruct the user to return to the beginning of the fifth segment or instead, the instructions could simply be repeated. It is also a feature of one embodiment of the present invention to provide a musical note associated with each type of stitch. The music can be composed which will become recognizable to the viewer as a reminder to follow the stitch pattern appropriately. This music or audible instruction is generally indicated by reference number.

In accordance with the exemplary embodiment, the instructional portion 116 contains a seventh segment, referred to as the first arm portion 130. At the beginning of the seventh segment, the narrator informs the user that the video is now going to provide instruction as to how to create the first arm portion 130. The eighth segment of the instructional portion 116 is, referred to as the second arm portion 132, which contains the same instructions as the first arm portion 130. Thus, the narrator could instruct the user to return to the beginning of the seventh segment or instead, the instructions could simply be repeated.

The digital graphic file 100 also includes an intermission portion 134. In the disclosed intermission portion 134, a Miyaki interrupts the instructional portion 116 and dances and sings to music. The intermission portion 134 is intended to provide a break to the user and they can be interspersed throughout the instructional portion 116 or throughout the entire digital graphic file 100 as desired. Additionally, it will be understood that any number of intermission portions 134 can be included in the digital graphic file 100 at a variety of different locations therein.

The next segment (the ninth segment) of the instructional portion 116 is the head and face portion 136. In accordance with the exemplary embodiment, at the beginning of the ninth segment, the narrator informs the user that the digital graphic file 100 is now going to provide instruction as to how to create the head and face portion 136. In the head and face portion 136, the user is allowed to customize the monkey's face and head to provide different and unique looks as dictated by the user. The instruction in the head and face portion 136 preferably includes embroidery and beading as well as crochet techniques. The instruction also preferably includes a combination of digital animation techniques and three-dimensional modeling.

Once the head and face portion 136 is complete, the instructional portion 116 contains a body portion 138. In accordance with the exemplary embodiment, at the beginning of the seventh segment, the narrator informs the user that the digital graphic file 100 is now going to provide instruction as to how to create the body portion 138. The instruction in the body portion 138, includes a combination of digital animation techniques.

Once the body portion 138 is complete, the instructional portion 116 contains an eleventh segment, referred to as the final assembly portion 140. In the final assembly portion 140, the narrator informs the user that before the back is closed, the tail, head, and other limbs must be attached. In accordance with this exemplary embodiment, a video image of a monkey dissolves into a three-dimensional graphic model which can be rotated and viewed from various angles, to better show exactly where and how the arms, legs, tail and head are to be attached to the body.

Once the final assembly portion 140 is complete, the instructional portion 116 contains a twelfth segment, referred to as the closure portion 142. In the closure portion 142, the narrator instructs the user to stuff the body portion 138 with fiberfill and close the back. This segment contains digital animated chart symbols that assist in clarifying the closure process.

The digital graphic file 100 contains a concluding segment that follows the instructional portion 116. In the concluding segment, the narrator informs the user that they are complete with the graphic pattern design. Thereafter, the credits for the advertisers as well as other important information is scrolled through across the screen. It will be understood that the concluding segment can contain a variety of other information.

It should be appreciated that the digital graphic file 100 can include other segments. For example, the digital graphic file 100 can include a music video portion. In this embodiment, the music video portion contains photos and clips of crochet artwork of potential interest. This includes photos and clips from around the world. It will be understood that the digital graphic file 100 can contain a variety of other segments. Further, each DVD or file could contain information on more than one pattern design.

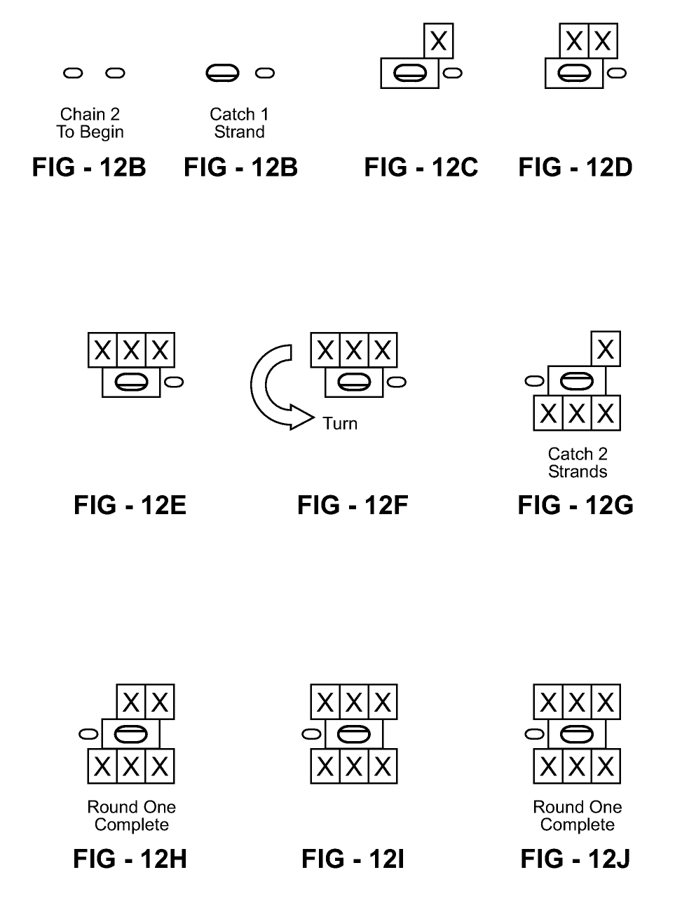

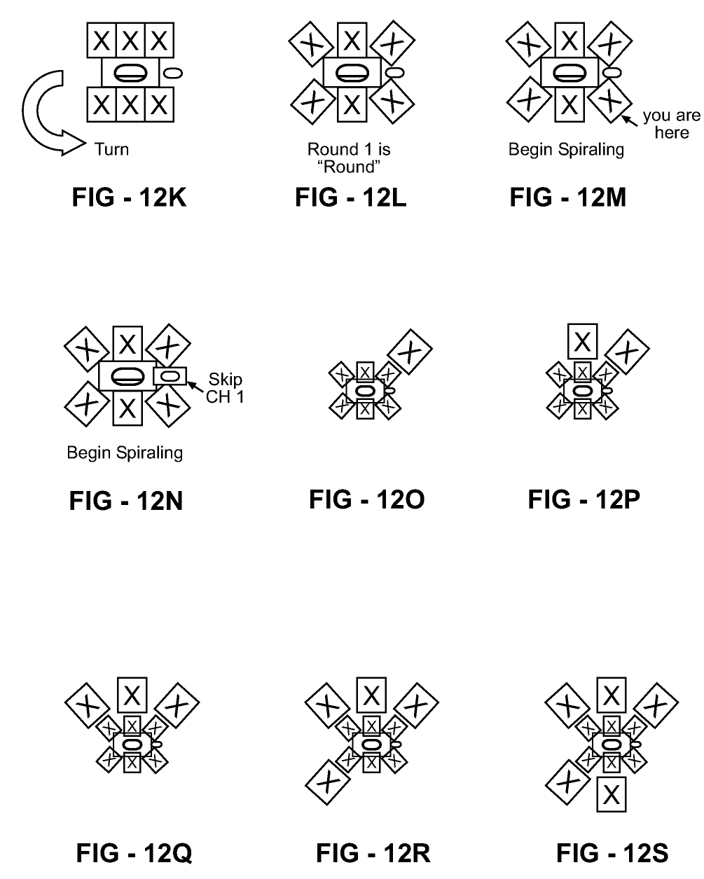

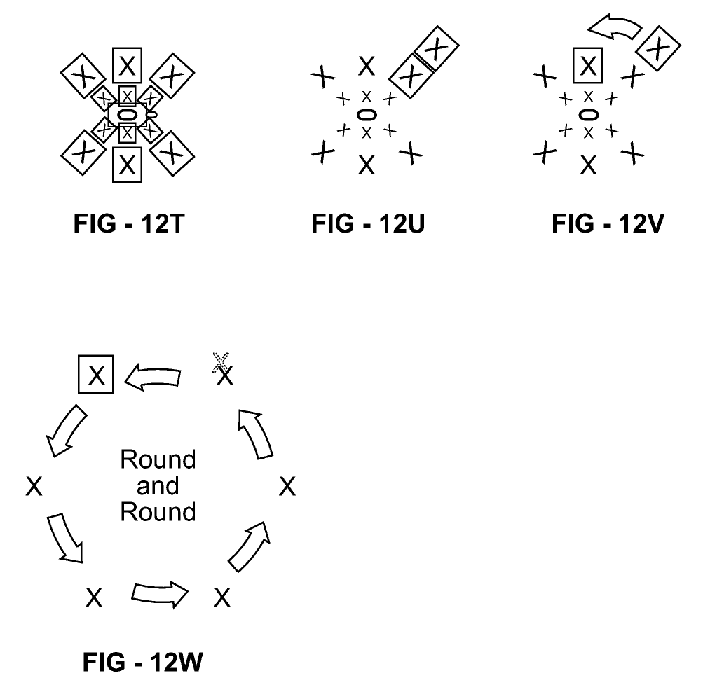

Referring now to FIGS. 12a through 12j, which illustrate the animated image object 22 of the monkey foot segment of the instructional portion 116 in accordance with the exemplary embodiment above. Specifically, FIGS. 12a through 12j illustrate symbols that take a viewer step by step through the stitches required to complete a level or round of the monkey foot. FIG. 12k instructs the viewer to turn. FIG. 121 instructs the viewer to round out the pattern to conform to the shape of the foot of the monkey.

FIGS. 12m through 12w walk the user through the remaining steps to complete the monkey foot, by stitching round and round. The viewer is instructed to continue round and round with the symbol for each stitch to be completed shown for the viewer.

Having now fully described the invention, it will be apparent to one of ordinary skill in the art that many changes and modifications can be made thereto without departing from the spirit or scope of the invention as set forth herein.

What is claimed is:

1. An instructional device for teaching yarncraft comprising;
a digital graphic file for transmission on an electronic device to a crafter,
said digital graphic file including a video object for audio-visually instructing the crafter to perform at least a first yarncraft maneuver, and
said digital graphic file including an animated image object corresponding to said video object for representing the first yarncraft maneuver.

2. A device as set forth in claim 1 wherein said animated image object includes a symbolic representation of the first yarncraft maneuver.

3. A device as set forth in claim 2 wherein said symbolic representation is an international stitch symbol.

4. A device as set forth in claim 2 wherein said symbolic representation includes a first sound pattern for association with the first yarncraft maneuver.

5. A device as set forth in claim 4 wherein said symbolic representation includes a second sound pattern for association with a second yarncraft maneuver and wherein said second sound pattern combines with said first sound pattern to form a repeatable melody for corresponding to a plurality of yarncraft maneuvers that includes at least the first and second yarncraft maneuvers.

6. A device as set forth in claim 2 wherein said symbolic representation includes a graphical representation for representing the first yarncraft maneuver.

7. A device as set forth in claim 6 wherein said graphical representation includes at least one virtual hand for demonstrating the first yarncraft maneuver.

8. A device as set forth in claim 6 wherein said graphical representation includes a flyaround view for displaying the first yarncraft maneuver from a plurality of viewing angles.

9. A device as set forth in claim 1 wherein said animated image object includes a virtual assembly for visualizing completion of a yarncraft project.

10. An instructional device for teaching yarncraft comprising;
a digital graphic file for transmission on an electronic device to a crafter,
said digital graphic file including an introduction portion,
said digital graphic file including an instructional portion,
said instruction portion including a video object for audio-visually instructing the crafter to perform a plurality of yarncraft maneuvers,
said instruction portion including an animated image object corresponding to said video object,
said animated image object including a plurality of symbolic representations for defining the yarncraft maneuvers,
said symbolic representations including at least one international stitch symbol,
said symbolic representations including a graphical representation for defining the yarncraft maneuvers,
said graphical representation including a pair of virtual hands for demonstrating the yarncraft maneuvers,
said graphical representation including a flyaround view for displaying the yarncraft maneuvers from a plurality of viewing angles,
said graphical representation including a virtual assembly for visualizing completion of a yarncraft project, and
said digital graphic file including a status indicator for indicating progress of the yarncraft project.

11. A method of yarncraft instruction comprising;
providing a digital graphic file that includes a video object and an animated image object,
transmitting the video object to a crafter to audio-visually instruct the crafter to perform at least a first yarncraft maneuver,
transmitting the animated image object representing the first yarncraft maneuver to the crafter, and
said transmitting steps being performed concurrently such that the animated image object corresponds to the video object.

12. A method as set forth in claim 11 wherein said step of transmitting the animated image object is further defined as transmitting a symbolic representation of the first yarncraft maneuver.

13. A method as set forth in claim 12 wherein said step of transmitting the symbolic representation is further defined as transmitting an international stitch symbol corresponding to the first yarncraft maneuver.

14. A method as set forth in claim 12 wherein said step of transmitting the symbolic representation is further defined as transmitting a first sound pattern corresponding to the first yarncraft maneuver.

15. A method as set forth in claim 14 wherein said step of transmitting the symbolic representation is further defined as transmitting a second sound pattern corresponding to a second yarncraft maneuver and combining the first and second sound patterns into a repeatable melody.

16. A method as set forth in claim 12 wherein said step of transmitting the symbolic representation is further defined as transmitting a graphical representation of the first yarncraft maneuver.

17. A method as set forth in claim 16 wherein said step of transmitting the graphical representation is further defined as displaying at least one virtual hand to demonstrate the first yarncraft maneuver.

18. A method as set forth in claim 16 wherein said step of transmitting the graphical representation is further defined as manipulating a flyaround view to display the yarncraft maneuver from a plurality of viewing angles.

19. A method as set forth in claim 16 wherein said steps of transmitting the graphical representation and transmitting the video object are further defined as correlating a series of graphical instructions from the animated image object with a series of yarncraft steps from the video object and displaying simultaneously the graphical instructions and yarncraft steps to the crafter.

20. A method as set forth in claim 11 wherein said step of transmitting the animated image object is further defined as building a virtual assembly to visualize completion of a yarncraft project.
